(19) United States
(12) Patent Application Publication
(10) Pub. No.: US 2025/0276367 A1
(43) Pub. Date: Sep. 4, 2025

(54) GAS FLOW MONITORING FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,191

(22) Filed: Mar. 1, 2024

(51) Int. Cl. B22F 10/322; B22F 10/28; B22F 10/85; B22F 12/90; B23K 26/342; B33Y 10/00; B33Y 30/00; B33Y 50/02; G06T 7/00; G06T 7/60

(52) U.S. Cl. CPC B22F 10/322; B22F 10/28; B22F 10/85; B22F 12/90; B23K 26/342; B33Y 10/00; B33Y 30/00; B33Y 50/02; G06T 7/0004; G06T 7/60; G06T 2207/30108

(57) ABSTRACT

An additive manufacturing system includes an energy delivery device configured to deliver energy to a build surface of a component to form a melt pool in the build surface of the component, a powder delivery device configured to direct a powder stream toward the melt pool, a gas delivery device configured to direct a gas stream toward or adjacent to the melt pool, at least one Schlieren imaging sensor configured to generate image data representative of a gas flow of one or more gas streams from the gas delivery device, and a computing device configured to receive the image data from the at least one Schlieren imaging sensor. The computing device is configured to determine a gas flow profile of the gas flow based on the image data and control the energy delivery device, gas delivery device and/or the powder delivery device based on the gas flow profile.

### TECHNICAL FIELD The disclosure relates to additive manufacturing systems and techniques.

### BACKGROUND

Additive manufacturing systems generate three-dimensional structures through addition of material layer-by-layer or volume-by-volume to form the structure, rather than removing material from an existing component to generate the three-dimensional structure. Additive manufacturing processes may be advantageous in many situations, such as rapid prototyping, forming components with complex three-dimensional structures, or the like. In some examples, additive manufacturing processes may utilize powdered materials, and may melt or sinter the powdered material together in predetermined shapes to form the three-dimensional structures. Variations in process conditions may result in defects and differences in microstructure in the three-dimensional structures.

### SUMMARY

The disclosure describes additive manufacturing systems, and methods for operating additive manufacturing systems, that fabricate a component according to deposition parameters that may be selected or adjusted using image data of a gas flow. An additive manufacturing system includes an energy delivery device that delivers energy to a build surface of a component to form a melt pool, a powder delivery device that directs a powder stream toward the melt pool, and a gas delivery device that directs a gas stream toward the melt pool to deliver the powder and create an inert atmosphere at the melt pool. The image data is generated by a Schlieren imaging sensor, and is representative of a spatial distribution of a density of the gas flow. A computing device uses the image data to determine a gas flow profile of the gas flow. For example, the image data may provide an indication of various characteristics of the gas flow, such as velocity, directionality, and/or composition, near a surface of the melt pool that can be characterized by the gas flow profile. These characteristics may be associated with adverse effects, such as convective cooling and gas contamination, that may reduce a build quality of the layer. The computing device controls the gas delivery device, the powder delivery device, and/or the energy delivery device based on the gas flow profile, such as by adjusting a temporal (e.g., flow rate) or spatial (e.g., distribution) parameter related to gas flow to alter the gas flow profile in a manner that reduces the adverse effects. The computing device may further determine a relationship between the gas flow profile and either the deposition parameters that create the gas flow profile or the material parameters that result from the gas flow profile, such as by using machine learning techniques, that may be used to control the gas flow profile in the same or subsequent additive manufacturing processes. In this way, additive manufacturing systems described herein may control the gas flow profile to produce layers with improved build quality.

In some examples, the disclosure describes an additive manufacturing system that includes an energy delivery device, a powder delivery device, a gas delivery device, one or more sensors, and a computing device. The energy delivery device is configured to deliver energy to a build surface of a component to form a melt pool in the build surface of the component. The powder delivery device is configured to direct a powder stream toward the melt pool. The gas delivery device is configured to direct one or more gas streams toward or adjacent to the melt pool. The one or more sensors include at least one Schlieren imaging sensor configured to generate image data representative of a gas flow of the one or more gas streams. The computing device is configured to receive the image data from the at least one Schlieren imaging sensor and determine a gas flow profile of the gas flow based on the image data. The gas flow profile is a representation of a spatial distribution of density of the gas flow. The computing device is further configured to control at least one of the energy delivery device, the powder delivery device, or the gas delivery device based on the gas flow profile.

In some examples, the disclosure describes a method for additive manufacturing that includes receiving, by a computing device, image data from one or more sensors of an additive manufacturing system. The one or more sensors include at least one Schlieren imaging sensor configured to generate the image data. The image data is representative of a gas flow of one or more gas streams from a gas delivery device. The method further includes determining, by the computing device and based on the image data, a gas flow profile of the gas flow. The method further includes controlling, by the computing device and based on the gas flow profile, at least one of an energy delivery device to deliver energy to a build surface of a component to form a melt pool in the build surface of the component, a powder delivery device to direct a powder stream toward the melt pool, or the gas delivery device to direct the one or more gas streams toward or adjacent to the melt pool.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating example gas flow monitoring aspects of an example additive manufacturing system.

FIG. 1B is a conceptual block diagram illustrating example gas flow monitoring sensors of a gas flow monitoring system and gas flow analysis modules of a computing device of an additive manufacturing system.

FIG. 1C is a conceptual block diagram illustrating example Schlieren imaging techniques for gas flow monitoring of an additive manufacturing system.

FIG. 1D is a side view diagram illustrating an example gas delivery device of an additive manufacturing system.

FIG. 2 is a process flow diagram illustrating a mass flux and heat flux monitoring and control technique.

FIG. 3 is a flowchart illustrating an example method for fabricating a component using Schlieren image data.

FIG. 4A is a conceptual diagram illustrating an example machine learning model.

FIG. 4B is a conceptual diagram illustrating an example training process for a machine learning model.

### DETAILED DESCRIPTION

The disclosure generally describes techniques and systems for monitoring a spatial distribution of gas flow during a blown powder additive manufacturing technique, such as a directed energy deposition (DED) technique, and using the imaged spatial distribution to control fabrication of a component. During blown powder additive manufacturing, a component is built up by adding material in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate.

The properties of the final component, including the presence or absence of material defects and the resulting microstructure, are a function of a number of variables related to mass flux and heat flux. As such, measurement of mass flux and heat flux within the blown powder additive manufacturing system may enable characterization or prediction of final component properties, control of the blown powder additive manufacturing technique, quality assurance for the final component, and the like. Mass flux and heat flux measurements may relate to parameters of powder flow rate and melt pool size and temperature, respectively, and may not provide an accurate characterization of an as-deposited layer. For example, a gas delivery device may discharge various gas streams, such as a purge gas stream, a shield gas stream, or a carrier gas stream, that generate turbulence and other conditions near a deposition surface. These conditions may cause convective cooling and gas impurities that lead to variation in microstructure of the as-deposited layer, and may not be measured by powder flow measurement techniques.

In accordance with techniques of this disclosure, an additive manufacturing system includes a Schlieren imaging sensor for imaging a spatial distribution of a gas flow (“gas flow profile”) near the melt pool and a computing device that adaptively controls deposition based on the spatial distribution. The gas flow profile may provide information as to how various operating parameters of the gas delivery device, the powder delivery device, and the energy delivery device affect local deposition conditions at the melt pool. For example, a particular set of deposition parameters may produce a gas flow profile that deposits a layer having a particular thickness, roughness, microstructure, or other parameter. This gas flow profile may be a result of the combination of gas streams and temperature and pressure conditions near the melt pool. The computing device may use the gas flow profile to select or adjust deposition parameters to produce a layer having the desired parameters. In this way, additive manufacturing systems may more accurately produce a layer having the desired parameters compared to systems that so not use Schlieren image data to control deposition parameters.

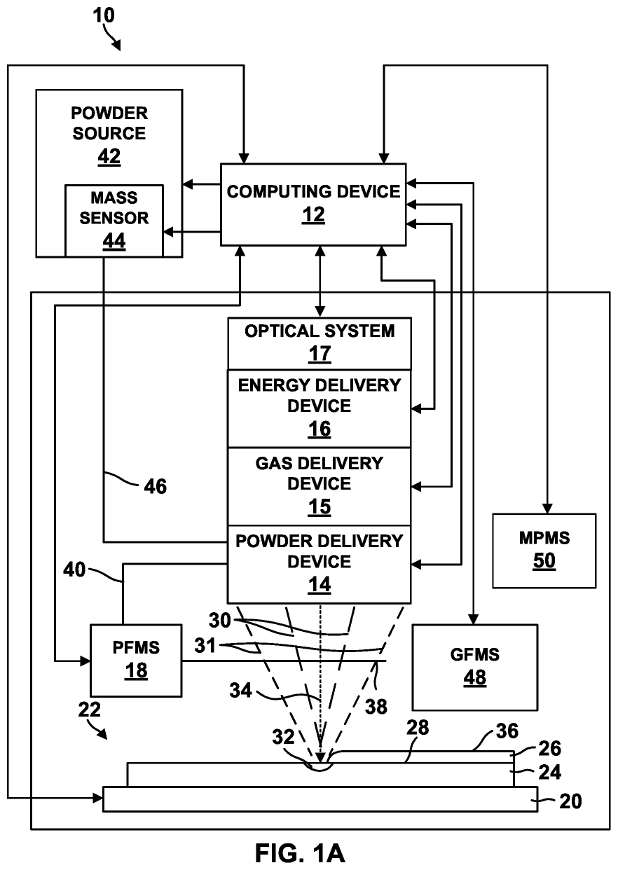

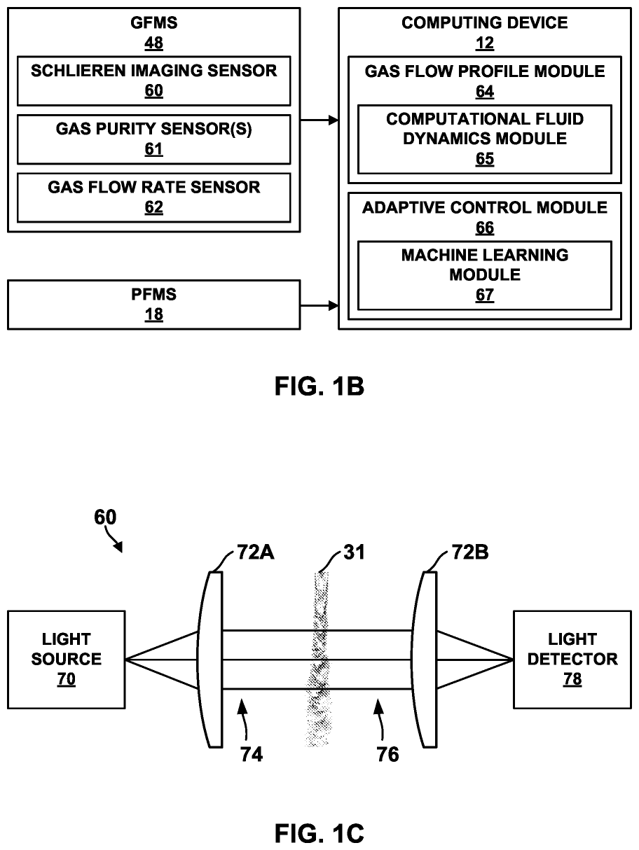

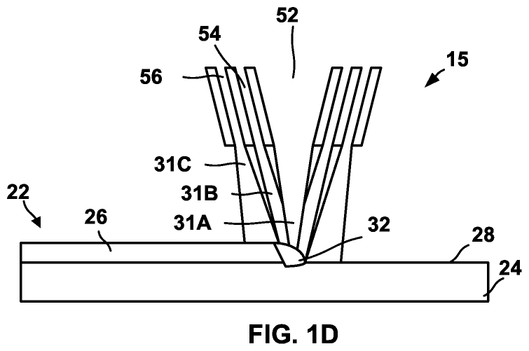

FIG. 1A is a conceptual block diagram illustrating an example additive manufacturing system 10 configured to monitor a gas flow during an additive manufacturing technique. In the example illustrated in FIG. 1A, additive manufacturing system 10 includes a computing device 12, a powder delivery device 14, a gas delivery device 15, an energy delivery device 16, a powder flow monitoring system (PFMS) 18, a melt pool monitoring system (MPMS) 56, an optical system 17, a stage 20, a powder source 42, a powder source mass sensor 44, and a gas flow monitoring system (GFMS) 48.

Stage 20 is configured to position component 22 during an additive manufacturing process. In some examples, stage 20 is movable relative to powder delivery device 14, gas delivery device 15, and/or energy delivery device 16. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source from gas delivery device 15, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1A, for at least part of flow path 46 between powder source 42 and nozzles of powder delivery device 14, flow path 46 may split into multiple, parallel sections, e.g., one for each nozzle. Further, although not shown in FIG. 1A, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder and gas flow, such that the combined powder and gas flow defines powder stream 30 focused at a focus plane. As powder delivery device 14 is movable in the z-axis shown in FIG. 1A relative to component 22, the focal plane of powder delivery device 14 also may be movable in the z-axis relative to component 22, such that the focus plane may be controlled to be substantially coincident with build surface 28.

Gas delivery device 15 may be configured to deliver one or more gas stream to selected locations of component 22, such as toward or adjacent to melt pool 32. The one or more gas streams may include an inert (or shielding) gas, such as argon or nitrogen gas, that maintains an inert atmosphere near melt pool 32, and a carrier gas that delivers powder from powder delivery device 14 to melt pool 32.

FIG. 1D is a side view diagram illustrating an example gas delivery device 15 of additive manufacturing system 10. In the example of FIG. 1D, gas delivery device 15 also operates as powder delivery device 16. Gas delivery device 15 is configured to discharge various gas streams 31 toward or adjacent to melt pool 32 to aid in depositing powder and/or creating an inert environment near melt pool 32. As such, gas delivery device 15 may utilize multiple gas streams coming out of different orifices. Some orifices may be annular (circular), while other orifices may be multi port (e.g., multi nozzle configuration). In the example of FIG. 1D, gas delivery device 15 includes a multiple orifice configuration, but a multiple nozzle configuration may be used.

Gas delivery device 15 includes a purge gas orifice 52, a carrier gas orifice 54, and a shielding gas orifice 56. Purge gas orifice 52 is configured to discharge purge gas stream 31A to purge an area at or adjacent to melt pool 32. Carrier gas orifice 54 is configured to discharge a carrier gas stream 31B that provides a drag force for flow of powder toward melt pool 32. Shielding gas orifice 56 is configured to discharge a shielding gas stream 31A (or nozzle gas) to provide an inert atmosphere near melt pool 32 and reduce any potential oxidation of deposited layers 26. In other examples, additional or alternative gas delivery devices may also be included, such as gas delivery devices configured to shield hot metal of layer 26 or preferentially cool an area of layer 26 to help produce a specific microstructure.

Use of multiple gas streams in gas delivery device 15 permits the use of multiple types of gases to help shield or cool the build/deposit. These gasses may interact in a very unique way based on the pressure, velocity, flow, shape, position/location/orientation of gas streams 31 in relationship to the others. As one example, for purge gas orifice 52 and carrier gas orifice 54, as a pressure and flow of purge gas is increased, purge gas stream 31A may push and disrupt powder stream 30 (not shown) and carrier gas stream 31B and change (e.g., lengthen) a focal point of powder stream 30, thereby increasing a size of a powder spot on melt pool 32 and thereby reducing a powder density (or powder capture rate) into melt pool 32. Increasing a number of gas streams makes the interaction and effect much more difficult to predict and adjust for. If deposition occurs in an atmospherically controlled glove box, then the interaction with the environment is also a factor. If the glove box is filled with Argon and Helium is used for the process gas (center purge, shield and powder stream) then this will act/respond differently in the Argon rich environment, then in a normal ambient air environment. Temperature effects (convection) should also be considered. As the substrate, deposit, nozzle, etc. heats then this will change the flow of gasses around the object of interest (build/deposit), so the initial, optimal gas flow may need to be adjusted to help maintain its optimal effect.

Despite their effects on the process performance, the one or more gas stream 31 from gas delivery device 15 may produce a gas flow that negatively affects deposition conditions near melt pool 32. For example, shielding gas stream 31C may cool down substrate 24 through convection, which may cause formation of porosities. As shown in the figure, there is a certain region in which powder particles and laser should converge that is called the convergence zone.

In some examples, powder delivery device 14 may be mechanically coupled or attached to energy delivery device 16 to facilitate delivery of powder stream 30 and energy 34 for forming melt pool 32 to substantially the same location adjacent to component 22. Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22.

As shown in FIG. 1A, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24).

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such greater than 1000 Hz.

To provide heat flow monitoring, system 10 may include melt pool monitoring system (MPMS) 50. MPMS 50 is configured to image at least a portion of melt pool 32 to detect parameters, such as size, temperature, or shape, of melt pool 32. For example, MPMS may be communicatively coupled to optical system 17 for observing thermal emissions around melt pool 32 and a thermal camera for monitoring a size and/or temperature of melt pool 32. Optical system 17 may include an imaging device and an associated optical train, which senses emissions at or near component 22 during the additive manufacturing technique. For example, optical system 17 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

In addition to mass flow monitoring and heat flow monitoring, system 10 includes gas flow monitoring. System 10 may monitor the gas flow to reduce or avoid formation of defects that may result from variation in effects, such as cooling rate or gas contamination, caused by parameters related to gas flow. For example, the temperature and cooling rate of melt pool 32 and the surrounding areas of first layer 24, as well as a composition of the carrier gas that carries the powder to melt pool 32, affect the microstructure of the component 22 formed using the additive manufacturing technique. Regarding cooling rate of melt pool 32, variation in cooling rate may result in microstructural heterogeneity, porosity, or other defects in the microstructure. Regarding gas impurities, presence of oxygen or another reactive gas may cause portions of melt pool 32 to oxidize, resulting in defects in the deposited layer.

To provide gas flow monitoring, system 10 may include gas flow monitoring system (GFMS) 48. GFMS 48 is configured to image at least a portion of gas stream 31 to detect gas flowing near build surface 28. GFMS 48 may include one or more sensors, including a Schlieren imaging sensor, configured to detect various parameters of the gas flow, such as density gradients, gas composition and purity, gas velocity, and/or gas flow rate. For example, while heat flow monitoring described above may be capable of monitoring temperature gradients near melt pool 32, such monitoring may be actionable primarily by modifying an amount of energy delivered to melt pool 32, which may be less responsive to temporal variation and unresponsive to spatial variation of temperature of melt pool 32. The imaging data from Schlieren imaging sensor will permit a clearer assessment of the effect of the gas streams 31 and a better idea of how to adjust size, shape, flow, pressure, velocity position, type of gas, etc. of each gas stream to help accomplish shielding, cooling, or other deposition condition. As will be described further below, the properties of the gas flow detected by GFMS 48 may be correlated to anomalous or undesirable events and/or used to control the gas flow in a manner that reduces or avoid the anomalous or undesirable events.

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, optical system 17, MPMS 50, stage 20, powder source 42, powder source mass sensor 44, and/or GFMS 48 using respective communication connections. Although FIG. 1A illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, adjustable z-stage 40, and/or stage 20, to position component 22 relative to powder delivery device 14, energy delivery device 16, PFMS 18, MPMS 50, and/or GFMS 48 during additive manufacturing processes. For example, as described above, computing device 12 may control stage 20 and powder delivery device 14, energy delivery device 16, and/or adjustable z-stage 40 to translate and/or rotate along at least one axis to position component 22 relative to powder delivery device 14, energy delivery device 16, PFMS 18, MPMS 50, and/or GFMS 48. Positioning component 22 relative to powder delivery device 14, energy delivery device 16, PFMS 18, MPMS 50, and/or GFMS 48 may include positioning a predetermined surface (e.g., a surface to which material is to be added) of component 22 in a predetermined orientation relative to powder delivery device 14, energy delivery device 16, PFMS 18, MPMS 50, and/or GFMS 48.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a height of layers 24, 26, and a density of layers 24, 26. For example, the set of deposition parameters may include power, beam diameter, beam profile, and wavelength of energy delivery device 16; powder feed rate powder delivery device 14; gas feed rate of gas delivery device, such as feed rate of purge gas stream 31A, carrier gas stream 31B, and/or shielding gas stream 31C; scan speed and deposition path of stage 20 relative to energy delivery device 16 and powder delivery device 14; or any other operating parameters that may affect an amount and/or quality of material formed as layers 24, 26.

Computing device 12 may be configured to select deposition parameters that are configured to generate layers 24, 26, according to the desired physical parameters. As shown in FIG. 1A, component 22 may include a first layer 24 and a second layer 26, although many components may be formed of additional layers, such as tens of layers, hundreds of layers, thousands of layers, or the like. Component 22 in FIG. 1A is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14, gas delivery device 15, and energy delivery device 16 according to the set of operating parameters to form, on a surface 28 of first layer 24 of material, a second layer 26 of material. Computing device 12 may control energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32 and gas delivery device 15 to deliver gas stream 31 to or adjacent to melt pool 32. For example, computing device 12 may control the relative position of powder delivery device 14 and stage 20 to direct powder stream 30 at or on to melt pool 32.

Computing device 12 may control powder delivery device 14, gas delivery device 15, and energy delivery device 16 to move powder stream 30, gas stream 31, and energy 34 along build surface 28 in a pattern until layer 26 is complete. Computing device 12 may then control a z-axis position of stage 20 and/or powder delivery device 14, gas delivery device 15, and energy delivery device 16 such that melt pool 32 will be formed on surface 36 of second layer 26, and may control powder delivery device 14, gas delivery device 15, and energy delivery device 16 to move powder stream 30, gas stream 31, and energy 34 along build surface 28 in a pattern until layer 26 is complete.

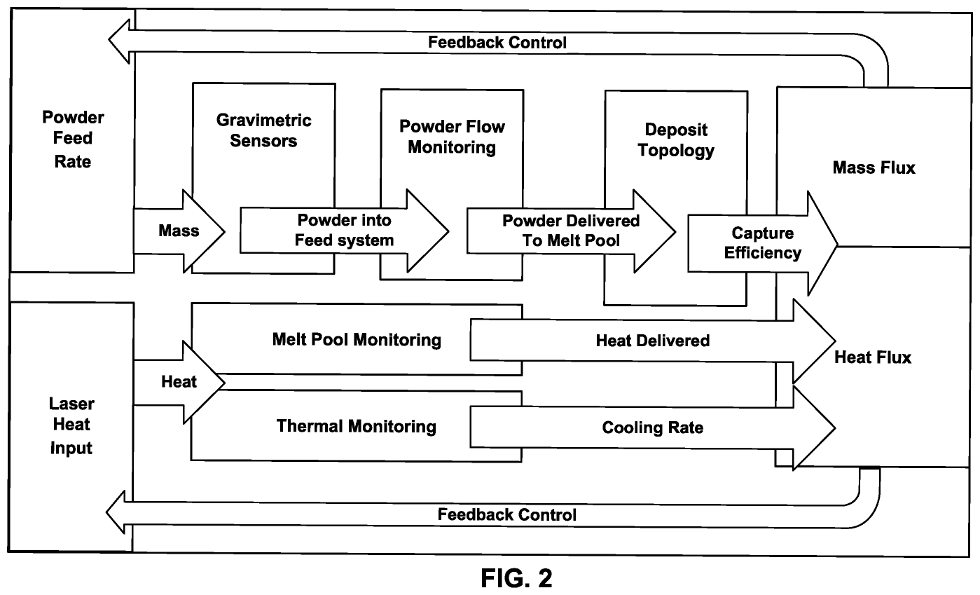

As mentioned above, system 10 may be configured with various in-situ monitoring techniques, including mass flux monitoring, heat flux monitoring, and gas flow monitoring, to control an additive manufacturing process and a subsequent subtractive manufacturing process. FIG. 2 is a process flow diagram illustrating a mass flux and heat flux monitoring and control technique. The technique of FIG. 2 may be implemented by system 10 of FIG. 1A and will be described with concurrent reference to FIG. 1A.

Computing device 12 may be configured to control a powder feed rate output by powder source 42 (see top left of FIG. 2). For instance, computing device 12 may be configured to control an agitator of powder source 42, a gas flow rate of gas flowing through powder source 42, a position of one or more valves within flow path 46, or the like to control a powder feed rate output by powder source 42. Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32.

Computing device 12 may calculate one or more mass flow-related metrics based on the data received from PFMS 18 and powder source mass sensor 44. For example, one or more computing devices 12 may determine a capture efficiency by determining a fraction or percentage of powder from powder stream 30 that is captured by melt pool 32 and added to component 22, e.g., by dividing the powder mass captured by melt pool 32 into the mass flow determined based on data received from PFMS 18. Further, computing device 12 may determine an overall mass flux using the data received from PFMS 18 and/or powder source mass sensor 44. One or more computing devices 12 then may use the overall mass flux as an input to the control algorithm used to control the powder feed rate output by powder source 42 (see top left of FIG. 2).

Similarly, computing device may be configured to control energy delivery device 16 to deliver energy 34 to first layer 24 to establish a given heat input (see bottom left of FIG.

2). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

Computing device 12 may be configured to receive data from one or more heat sensors, such as optical system 17 and/or MPMS 50. Computing device 12 may determine a cooling rate and associated heat from using data from optical system 17 and may determine a heat input into component using a size and/or temperature of melt pool 32 as observed by melt pool monitor. Computing device 12 may be configured to determine an overall heat flux using these data. Computing device 12 may then use the overall heat flux as an input to the control algorithm used to control the energy delivery by energy delivery device 16 (see top left of FIG. 2).

Referring back to FIG. 1A, computing device 12 may be configured to control a gas flow output by powder delivery device 14. For instance, computing device 12 may be configured to control a gas flow rate of gas flowing from gas delivery device 14, a position of one or more nozzles or orifices of gas delivery device 14, or the like to control a velocity, directionality, and/or composition of a gas flow output by gas delivery device 14.

FIG. 1B is a conceptual block diagram illustrating example gas flow monitoring sensors of a gas flow monitoring system (GFMS) 48 and gas flow analysis and control modules of a computing device 12 of an additive manufacturing system, such as additive manufacturing system 10. Computing device 12 may be communicatively coupled to GFMS 48 and PFMS 18 to receive data from GFMS 48 and PFMS 18.

GFMS 48 includes one or more sensors configured to detect one or more parameters of system 10 related to gas flow, generate sensor data representative of the parameters, and send the sensor data to computing device 12. In the example of FIG. 1B, GFMS 48 includes a Schlieren imaging sensor 60, one or more gas purity sensors 61, and a gas flow rate sensor 62. However, GFMS 48 may include other sensors that measure parameters related to gas flow, such as a velocity, directionality, or composition of gas flow. Computing device 12 may be configured to receive sensor data from the one or more gas flow monitoring sensors.

GFMS 48 includes at least one Schlieren imaging sensor 60. Schlieren imaging sensor 60 is configured to generate image data representative of a gas flow of a gas delivery device, such as gas delivery device 15. Schlieren image data may include any image data that represents spatial variation of refractive indices of gas in the gas flow, as measured by light passing through gas stream 31. FIG. 1C is a conceptual block diagram illustrating example Schlieren imaging sensor 60 for gas flow monitoring of an additive manufacturing system. Schlieren imaging sensor 60 includes a light source 70, a light detector 78, and optional collimating optics 72A and focusing optics 72B. Light source 70 is configured to generate light that is collimated by collimating optics 72A to produce collimated light 74. In other examples, light source 70 may produce collimated light 74, such as laser light, or may not include a light source 70, instead using an external light source. While only a single beam of collimated light 74 is shown, sensor 60 may include multiple light sources 70 creating multiple beams of collimated light 74, such that gas flow may be imaged from more than one direction (e.g., along an x-axis and y-axis, each perpendicular to gas flow).

Without being limited to any particular theory or arrangement, Schlieren imaging sensor 60 may be configured to generate image data representative of a spatial distribution of density of a gas flow in gas stream 31 by measuring light that is refracted while passing through the gas flow. Collimated light 74 passes through gas flow of gas stream 31. Variations in the gas flow, such as variations in a velocity of the gas flow, direction of the gas flow, and/or composition of the gas flow, may result in spatial variation of density of gas, and corresponding spatial variation in refractive indices, in the gas flow. The spatial variation in refractive indices causes some of collimated light 74 to deviate and produce distorted light 76. For example, turbulence or other variations in a velocity or directionality of fluid flow may produce scintillation that causes collimated light 74 to deflect, creating a spatially varying intensity of light that reflects the gas flow. Focusing optics 72B may be configured to focus distorted light 76.

Light detector 78 is configured to detect distorted light 76. For example, light detector 78 may be configured to detect an intensity of distorted light 76 at an array of points over an area, such that spatial variation in the intensity may result in an image of the gas flow that represents the variation in refractive indices. In some examples, light detector 78 includes further post-processing systems, such as a knife edge or other stop to filter or block a portion of distorted light 76 and image a particular range of density gradients in distorted light 76.

Schlieren imaging sensor 60 may be configured to generate image data that provides sufficient information for computing device 12, alone or in combination with other sensor or modelling data, to characterize the gas flow. For example, the spatial and temporal variation represented in the image data may describe the flow path (e.g., velocity and direction) and composition of gas in the gas flow, including changes in a direction of gas flow, turbulence in gas flow, and changes in composition of gas flow. These parameters may affect the resulting microstructure of the melted or sintered powder. For example, the velocity, direction, and turbulence of the gas flow may impact convective cooling of melt pool 32. As another example, the composition of the gas flow may impact any reactions, or lack thereof, between the melted or sintered powder and the gas.

Referring back to FIG. 1B, GFMS 48 may include additional sensors configured to detect one or more parameters of the gas flow. Such parameters of the gas flow may include, but are not limited to, a velocity of the gas flow, a mass flow rate of the gas flow, a volumetric flow rate of the gas flow, a turbulence of the gas flow, a volume fraction of the gas flow with respect to the powder flow, a composition of the gas flow, a temperature of the gas flow, or any other parameter of the gas flow that may affect a material property of the as-deposited layer and/or may be modified through deposition parameters of powder delivery device 14, gas delivery device 15, and/or energy delivery device 16.

In some examples, GFMS 48 may include one or more gas purity sensors 61. Gas purity sensor 61 may be configured to detect an amount of a particular gas or combination of gases, including inert gases such as nitrogen gas or argon and/or reactive gases such as oxygen gas, in the gas flow. Gas purity data provided by gas purity sensor 61 may indicate whether any reactive gases may be present in the gas flow. For example, turbulent gas flow near melt pool 32 may cause oxygen in a nearby atmosphere to mix with the inert gas discharged by gas delivery device 15, resulting in a presence or increase in concentration of oxygen in the gas flow. Gas purity sensor 61, alone or in combination with Schlieren imaging sensor 60, may detect a change in composition of the gas flow that corresponds to the presence or increase in oxygen gas (or other gas species indicative of the presence or increase in a reactive gas).

In some examples, GFMS 48 may include a gas flow rate sensor 62. Gas flow rate sensor may be configured to detect a flow rate of the gas flow. The gas flow rate may include a volumetric flow rate or a mass flow rate of the gas flow. Gas flow rate data provided by gas flow rate sensor 62 may indicate an amount of convective cooling at melt pool 32. For example, an amount of heat transfer from melt pool 32 to the gas may be related to a mass flow rate of the gas flow, a temperature of the gas flow, and convection heat transfer coefficient of the gas or gases in the gas flow and its corresponding factors (e.g., velocity of gas flow, thermal conductivity of the gases, type of flow (e.g., laminar or turbulent)).

In addition to gas flow, powder flow may also provide an indication as to various parameters of the gas flow. PFMS 18 may be configured to detect one or more parameters of system 10 related to powder flow, generate sensor data, and send the sensor data to computing device 12. Sensor data from PFMS 18 may indicate a mass flow of powder in powder stream 30 between powder delivery device 14 to adjacent melt pool 32.

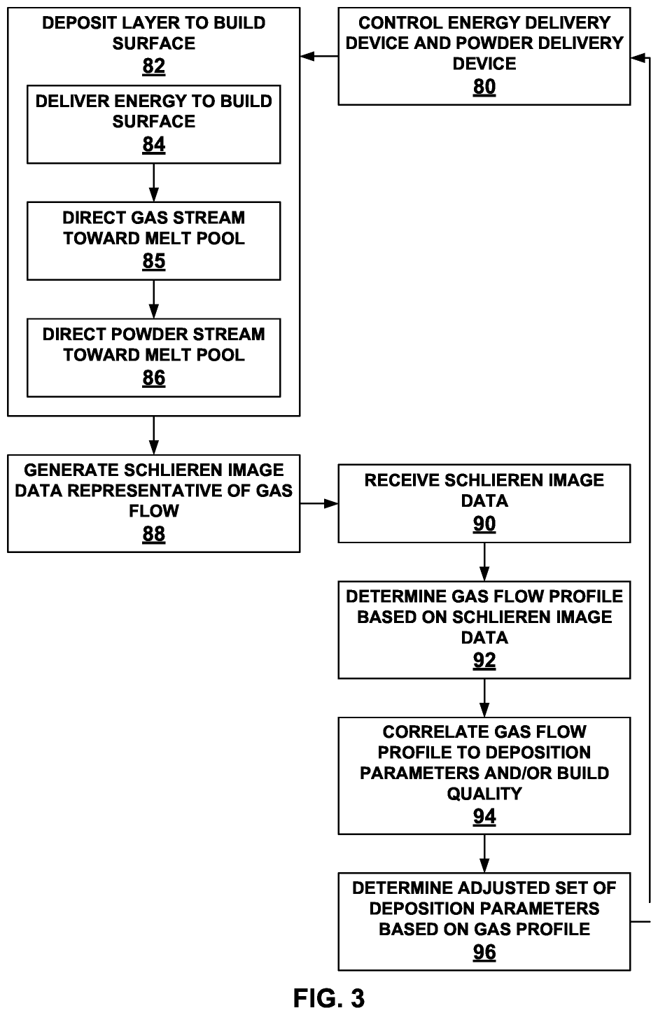

Computing device 12 is configured to analyze the sensor data, including the Schlieren image data, characterize the gas flow based on the sensor data, and control fabrication of a component based on the characterized gas flow. Computing device 12 includes a gas flow profile module 64, including an optional computational fluid dynamics (CFD) module 65, and an adaptive control module 66, including an optional machine learning module 67. FIG. 3 is a flowchart illustrating an example additive manufacturing method for fabricating a component using Schlieren image data. Operation of computing device 12 will be described with respect to the method of FIG. 3. While computing device 12 will be described with respect to modules 64-67, it will be understood that various modules may be performed by other computing devices. For example, CFD module 65 and machine learning module 67 may be part of separate computing devices, such as specialized computing devices for implementing computation fluid dynamic modelling and machine learning techniques.

The method includes controlling energy delivery device 16, gas delivery device 15, and powder delivery device 14 (80). Adaptive control module 66 is configured to control energy delivery device 16, gas delivery device 15, and powder delivery device 14 according to a set of deposition parameters which, as will be described further below, are at least partly based on a gas flow profile. For example, control module 66 may send control signals to energy delivery device 16, gas delivery device 15, and powder delivery device 14 that control energy delivery device 16, gas delivery device 15, and powder delivery device 14 to generate energy 34, gas stream 31, and powder stream 30 according to particular parameters. As a result, energy delivery device 16 and powder delivery device 14 may deposit a layer on a build surface based on the control signals (82). For example, energy delivery device 16 may deliver energy to a build surface of a component to form a melt pool in the build surface of the component (84), gas delivery device 15 may direct one or more gas streams toward or adjacent to melt pool (85), and powder delivery device 14 may direct a powder stream toward the melt pool (86).

The method includes generating sensor data, including Schlieren image data representative of a gas flow of gas delivery device 15 (88). For example, Schlieren imaging sensor 60 may capture a spatial distribution of an intensity of light refracted through gas stream 31. Schlieren imaging sensor 60 may capture the light at particular periods to generate a temporal representation of the spatial distribution of the light, such that the image data may approximate video data or other image data having a temporal component.

The method includes receiving Schlieren image data (90). In some examples, computing device 12 may receive the sensor data as powder delivery device 14, gas delivery device 15, and energy delivery device 16 deliver powder, gas (e.g., purge, carrier, and/or shielding gas), and energy, respectively, to the build surface. For example, the sensor data may reflect local conditions of the gas flow in real time, such that computing device 12 may use the sensor data as immediate feedback. In some examples, computing device 12 may receive the sensor data after powder delivery device 14, gas delivery device 15, and energy delivery device 16 deliver powder, gas, and energy, respectively, to the build surface. For example, the sensor data may reflect global conditions of the gas flow, such as for a particular layer or several layers, such that computing device 12 may use the sensor data as extended feedback for adjusting operation of powder delivery device 14, gas delivery device 15, and/or energy delivery device 16 during a particular or subsequent build. In some examples, the method includes receiving additional sensor data, such as from at least one of gas purity sensor 61 or gas flow rate sensor 62.

The method includes determining a gas flow profile of the gas flow based on the image data (92). Gas flow profile module 64 is configured to determine a gas flow profile of the gas flow based on the image data. The gas flow profile is a representation of a spatial, and optionally temporal, distribution of gases in the gas flow. The gas flow profile may generate sufficient information from the sensor data for adaptive control module 66 to correlate characteristics of the gas flow with either/both deposition parameters that affect the gas flow or/and material parameters that are influenced by the gas flow.

In some examples, the gas flow profile may include parameters of the gas flow, such as a velocity, directionality, and/or composition of the gases in the gas flow. For example, the gas flow profile may include parameters that may be determined by analyzing various properties of the image data, alone or in combination with other sensor or model data. In such examples, determining the gas flow profile may include determining one or more gas flow-related parameters or metrics based on the sensor data received from GFMS 48, and optionally, PFMS 18. For example, gas flow profile module 64 may use one or more optical recognition techniques to analyze the image data and determine a flow rate of the gas flow, a velocity of the gas flow, a gas purity of the gas flow, a composition of the gas flow, or any other gas flow parameter that may be determined based on a spatial and/or temporal distribution of refractive index. As will be described below, adaptive control module 66 may use one or more of these gas flow parameters as an input to a control algorithm used to control the gas flow rate or shape gas flow output by gas delivery device 15.

In some examples, determining the gas flow profile includes computational fluid dynamics (CFD) modelling. Gas flow profile module 64 may include CFD module 65 configured to determine the gas flow profile based on CFD modelling. CFD module 65 may use computer-based numerical methods and algorithms to simulate and analyze the behavior of the gas flow. Such behavior may be challenging or impractical to determine through visual or experimental methods. The gas flow profile may include a computational fluid dynamics (CFD) model that is at least partly based on the image data.

CFD module 65 may determine the gas flow profile by generating a CFD model, comparing the image data with the CFD model to identify differences in a velocity or directionality of the gas flow, and adjusting one or more parameters of the CFD model such that the CFD model more closely matches the image data. The resulting CFD model may represent the gas flow profile. CFD module 65 may generate CFD models based on fundamental equations of fluid dynamics which describe the conservation of mass, momentum, and energy in the gas flow. CFD module 65 may generate a grid or mesh of discrete elements, and the various equations may be solved numerically at each grid point to simulate the flow and calculate the flow variables such as velocity and directionality. CFD module 65 may further define boundary conditions related to the gas flow, such as boundary conditions at an edge of powder stream 30, an interface with melt pool 32, or other boundary of the gas flow with a surface or atmosphere. CFD module 65 may generate a CFD module that accounts for turbulence, such as through a turbulence module, that simulates the effects of turbulence and its impact on heat and mass transfer. CFD module 65 may be further configured to apply post-processing techniques to extract relevant information from the CFD model. Such post-processing may include visualization to represent the gas flow field, temperature distribution, and other gas flow parameters in a form that may be used to modify deposition parameters.

CFD module 65 may be further configured to validate the CFD model using the image data. For example, one or more outputs from the CFD model may be compared with the image data. Based on this comparison, one or more parameters of the CFD model may be adjusted to reduce a difference between the CFD model and the image data. As a result, the CFD model may more closely represent real-world conditions of the gas flow.

In some examples, the gas flow profile may include relatively unprocessed or minimally processed image data that may reflect the gas flow in real-time. For example, the gas flow profile may be a visual display of the image data in real-time or near real-time that may visually indicate a response of the gas flow to a change in one or more deposition parameters of powder delivery device 14, gas delivery device 15, and/or energy delivery device 16. In such examples, determining the gas flow profile may include collecting and storing the image data in a form that can be optically analyzed for patterns at a set of deposition parameters or a change in patterns in response to a change in deposition parameters.

The method includes correlating the gas flow profile with deposition parameters that influence the gas flow and/or build quality that results from the gas flow (94). Adaptive control module 66 may be configured to correlate the gas flow with the deposition parameters and/or material parameters corresponding to build quality. For example, parameters of the gas flow, such as the velocity and shape of the gas flow, may be influenced by the deposition parameters of gas delivery device 15, such as a flow rate of the gas flow, positioning of the gas flow, and the composition of the coverage gas in the gas flow. As another example, parameters of the gas flow may create deposition conditions, such as convective cooling and gas contamination, that influence the material parameters of the as-deposited layer, such as microstructure.

In some examples, adaptive control module 66 may correlate the gas flow profile with one or more deposition parameters controllable by gas delivery device 15, and optionally, powder delivery device 14 and/or energy delivery device 16. Adaptive control module 66 may be configured to analyze the gas flow profile with respect to deposition parameters and determine how a change in deposition parameters affects the gas flow profile. Particular gas flow profiles may be associated with desired build quality. For example, a less turbulent gas flow at melt pool 32 may cause relatively consistent convective heating at melt pool 32 and/or relatively low levels of impurity of external gases into the coverage gas, thereby improving build quality. Adaptive control module 66 may be configured to identify differences between the gas flow profile as indicated by the image data and the desired gas flow profile. Such identified differences may include visual differences in the gas flow profile and the desired gas flow profile, numerical differences in calculated parameters of the gas flow profile and the desired gas flow profile, and/or model differences in CFD models of the gas flow profile and the desired gas flow profile. Such differences may be used to analyze an effect of changing deposition parameters of powder delivery device 14, gas delivery device 15, and/or energy delivery device 16, such as a gas flow rate, a gas flow positioning, a gas flow shape, a gas mixture, and any other factors of gas flow that may be controlled by gas delivery device 15.

In some examples, adaptive control module 66 may correlate the gas flow profile with one or more deposition anomalies. Deposition anomalies may include defects in the as-deposited layer that may be indicated by the gas flow. For example, a particular gas flow profile may result in spatter at melt pool 32. Such a gas flow profile may be differentiated and characterized based on various parameters of the gas flow profile, such that identification of the particular gas flow profile may indicate an increased likelihood of the deposition anomaly occurring. In some examples, adaptive control module 66 is configured to determine whether the gas flow profile corresponds to one or more deposition anomalies. The one or more deposition anomalies may include at least one of convective cooling of the build surface or gas contamination of the gas flow. Adaptive control module 66 is configured to control energy delivery device 16, gas delivery device 15, and powder delivery device 14 to reduce a magnitude or occurrence of the one or more deposition anomalies. For example, as discussed above, adaptive control module 66 may be configured to determine how deposition parameters affect the gas flow profile. Such identified deposition parameters may be adjusted to produce a different gas flow profile than the gas flow profile associated with the deposition anomalies. In other words, adaptive control module 66 may adjust to the deposition parameters to produce a desired gas flow profile or avoid an undesired gas flow profile.

In some examples, adaptive control module 66 may be configured to correlate the gas flow profile with one or more structural features of additive manufacturing system 10 or component 22. For example, particular structural features of additive manufacturing system 10, such as clamps, tools, or walls of an enclosure, or component 22, such as part geometry, may cause a deviation in the gas flow profile. Adaptive control module 66 may be configured to identify changes in the gas flow profile caused by the structural features, such that any deviations in gas flow profile for similar structural features may be predicted and reduced or avoided.

In some examples, computing device 12 may be configured to use machine learning techniques to identify an effect of deposition parameters on gas flow, identify an effect of gas flow on material parameters, and/or identify an effect of structural features of system 10 or component 22 on the gas flow. Such machine learning techniques may enable computing device 12 to adapt and optimize deposition parameters using the observed gas flow indicated by the image data.

In some examples, machine learning module 67 may be configured to correlate the gas flow profile with the one or more deposition parameters using one or more machine learning techniques. Machine learning module 67 may be configured to determine one or more deposition parameters based on observed behavior indicated by the image data using model-based reinforcement learning. Machine learning module 67 may be configured to learn a model of the gas flow behavior based on the image data and use this model to make decisions about an effect of one or more deposition parameters or change in one or more deposition parameters.

Machine learning module 67 may identify one or more deposition parameters related to gas flow, such as a gas flow rate, a nozzle or orifice shape, or other parameter of gas delivery device 15. Machine learning module 67 may further receive the gas flow profile and identify aspects of the gas flow profile that may be improved. For example, a gas flow profile that indicates a particular velocity or directionality of the gas flow may be associated with fewer defects in the as-deposited layer. Machine learning module 67 may receive the gas flow profile for gas flow at different sets of deposition parameters. As described above, the gas flow profile may include any combination of image data, parameters determined from the image data, or model data that at least partially incorporates the image data.

Machine learning module 67 may identify a machine learning algorithm that captures the relationship between the set of deposition parameters and the observed behavior as indicated by the gas flow profile. Models may include, but are not limited to, reinforcement learning models, such as deep reinforcement learning algorithms or traditional reinforcement learning algorithms. Machine learning module 67 may train the machine learning model using the gas flow profile. The model may learn the underlying patterns and relationships between the deposition parameters and the observed behavior as indicated by the gas flow profile. For example, machine learning module 67 may operate the model to improve a reward signal associated with the observed gas flow profile.

Machine learning module 67 may determine improved deposition parameters for a given set of conditions. For example, machine learning module 67 may use optimization methods, such as gradient-based methods or evolutionary algorithms, to tune the deposition parameters. Machine learning module 67 may further validate the model by analyzing gas flow profiles during fabrication of other layers and/or components.

Machine learning module 67 may be configured to correlate the gas flow profile with one or more deposition anomalies. Machine learning module 67 may be configured to determine one or more parameters of melt pool 32 and/or the as-deposited layer based on observed behavior indicated by the image data using model-based reinforcement learning. Machine learning module 67 may be configured to learn a model of the gas flow behavior based on the image data and use this model to make decisions about an effect of one or more material parameters or change in one or more material parameters.

Machine learning module 67 may identify one or more parameters that results from gas flow, such as a convective cooling rate, a gas purity, or other parameter of melt pool 32 and/or powder stream 30. Machine learning module 67 may further receive sensor information that provides indication of such parameters, such as temperature data of melt pool 32, topological data of the as-deposited layer, gas purity data, or any other data that may provide an indication of deposition conditions affected by the gas flow. Machine learning module 67 may further receive the gas flow profile and identify aspects of the gas flow profile that may be improved. Machine learning module 67 may receive the gas flow profile for gas flow resulting in different deposition conditions. As described above, the gas flow profile may include any combination of image data, parameters determined from the image data, or model data that at least partially incorporates the image data.

Machine learning module 67 may identify a machine learning algorithm that captures the relationship between the material parameters resulting from the gas flow and the observed behavior as indicated by the gas flow profile. Models may include, but are not limited to, reinforcement learning models, such as deep reinforcement learning algorithms or traditional reinforcement learning algorithms. Machine learning module 67 may train the machine learning model using the gas flow profile. The model may learn the underlying patterns and relationships between the material parameters and the observed behavior as indicated by the gas flow profile. For example, machine learning module 67 may operate the model to improve a reward signal associated with the observed gas flow profile.

Machine learning module 67 may determine improved deposition parameters for a given set of conditions. For example, machine learning module 67 may use optimization methods, such as gradient-based methods or evolutionary algorithms, to tune the deposition parameters. Machine learning module 67 may further validate the model by analyzing gas flow profiles during fabrication of other layers and/or components, and the resulting build quality that results from the gas flow profiles.

The method may include determining an adjusted set of deposition parameters based on the gas flow profile (96). Adaptive control module 66 may control gas delivery device 15 according to an adjusted set of deposition parameters that modify the gas flow based on the gas flow profile. Adaptive control module 69 may use correlations between the gas flow profile and the deposition parameters and correlations between the gas flow profile and the build quality to select a set of deposition parameters that modifies the gas flow profile to improve build quality. For example, adaptive control module 66 may generate control signals that cause gas delivery device 15 to modify any of a gas flow rate, a nozzle or orifice shape, or other parameter related to a velocity, directionality, or composition of the gas flow to achieve a gas flow profile that improves build quality, such as reduces gas contamination or reduces variability of convective cooling.

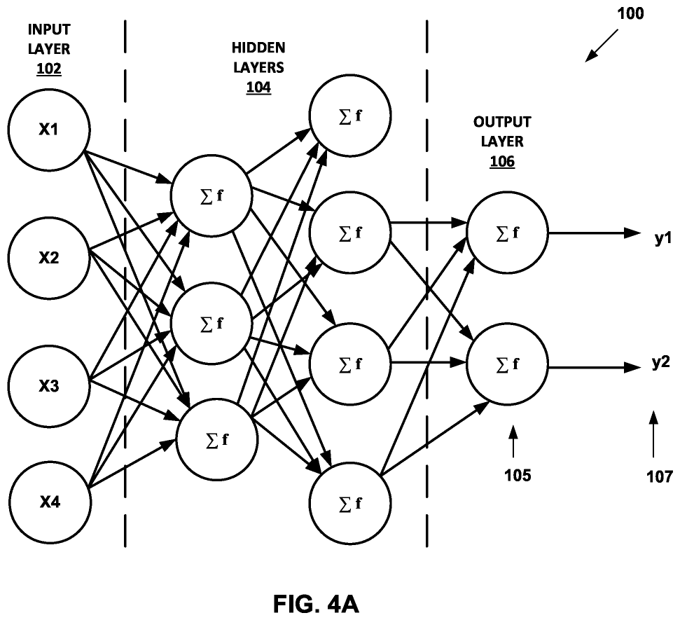

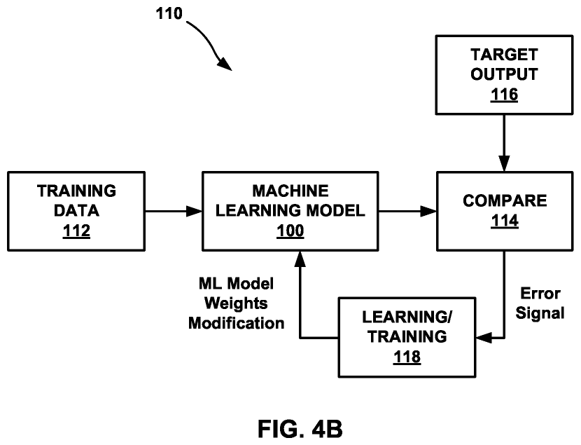

As explained in FIG. 1B with respect to machine learning module 67, additive manufacturing systems described herein may be configured to use machine learning processes for determining a relationship between a gas flow profile of the gas flow and various upstream deposition parameters that cause or downstream material parameters that result from the gas flow profile. FIG. 4A is a conceptual diagram illustrating an example machine learning model according to one or more aspects of this disclosure. Machine learning model 100 may be an example of a machine learning model implemented by machine learning module 67. Machine learning model 100 may be an example of a deep learning model, or deep learning algorithm, trained to determine deposition parameters, material parameters, or structural features associated with or influenced by a gas flow profile. Computing device 12 and/or another device, may train, store, and/or utilize machine learning model 100, but other devices of system 10 may apply inputs to machine learning model 100. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 4A, machine learning model 100 may include three types of layers. These three types of layers include input layer 102, hidden layers 104, and output layer 106. Output layer 106 includes the output from the transfer function 105 of output layer 106. Input layer 102 represents each of the input values X1 through X4 provided to machine learning model 100. In some examples, the input values may include any of the values input into the machine learning model, as described above. For example, the input values may include image data from Schlieren imaging sensor 60, gas purity data from gas purity sensor 61, gas flow rate data from gas flow rate sensor 62, or another other data received by computing device 12, as described above. In addition, in some examples input values of machine learning model 100 may include additional data, such as other data that may be collected by or stored in system 100, such as model data from computational fluid dynamics module 65.

Each of the input values for each node in the input layer 102 is provided to each node of a first layer of hidden layers 104. In the example of FIG. 4A, hidden layers 104 include two layers, one layer having four nodes and the other layer having three nodes, but fewer or greater number of nodes may be used in other examples. Each input from input layer 102 is multiplied by a weight and then summed at each node of hidden layers 104. During training of machine learning model 100, the weights for each input are adjusted to establish a relationship between image data and/or the gas flow profile derived from the image data and deposition parameters that generate the gas flow profile represented by the image data. In some examples, one hidden layer may be incorporated into machine learning model 100, or three or more hidden layers may be incorporated into machine learning model 100, where each layer includes the same or different number of nodes.

The result of each node within hidden layers 104 is applied to the transfer function of output layer 106. The transfer function may be linear or non-linear, depending on the number of layers within machine learning model 100. Example non-linear transfer functions may be a sigmoid function or a rectifier function. The output 107 of the transfer function may be a set of deposition parameters, or a set of material parameters, that correspond to a gas flow profile depicted in the image data.

As shown in the example above, by applying machine learning model 100 to input data such as image data, processing circuitry of computing device 12 is able to determine a relationship between deposition parameters that produce, material parameters the result from, and/or structural parameter that affect the gas flow profile based on image data. Computing device 12 may utilize such features to determine a local coordinate system, to map the local coordinate system to a global coordinate system, and/or to generate representations of the gas flow profile.

FIG. 4B is a conceptual diagram illustrating an example training process for a machine learning model according to one or more aspects of this disclosure. Process 110 may be used to train machine learning model 100. Machine learning model 100 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 100 based on a corpus of training data 112. Training data 112 may include, for example, previous image data of the gas flow, previous image data of other gas flows under different conditions, previous deposition parameters or material parameter data, and/or the like. Previous deposition parameter or material parameter data, for example, may include deposition parameters or material parameters associated with previous additive manufacturing processes. In some examples, the image data and/or deposition parameter or material parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of deposition parameters. Computing device 12 may use the NLP model to capture such details. In such an example, the machine learning model may analyze underlying characteristics associated with the powder, rather than powder flow factors, when determining a set of deposition parameters.

In some examples, training data 112 may include annotations identifying effects of deposition parameters indicated in image data of training data 112. Training data 112 may include data from past additive deposition processes performed on components having different geometries, formed from different materials, formed under different conditions, and/or the like.

While training machine learning model 100, computing device 12 may compare 114 a prediction or classification with a target output 116. Computing device 12 may utilize an error signal from the comparison to train (learning/training 118) machine learning model 100. Computing device 12 may generate machine learning model weights or other modifications which computing device 12 may use to modify machine learning model 100. For example, computing device 12 may modify the weights of machine learning model 100 based on the learning/training 118.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Example 1: An additive manufacturing system includes an energy delivery device configured to deliver energy to a build surface of a component to form a melt pool in the build surface of the component; a powder delivery device configured to direct a powder stream toward the melt pool; a gas delivery device configured to direct one or more gas streams toward or adjacent to the melt pool; one or more sensors includes receive the image data from the at least one Schlieren imaging sensor; determine a gas flow profile of the gas flow based on the image data, wherein the gas flow profile is a representation of a spatial distribution of density of the gas flow; and control at least one of the energy delivery device, the powder delivery device, or the gas delivery device based on the gas flow profile.

Example 2: The additive manufacturing system of example 1, wherein the powder delivery device and the gas delivery device each comprise one or more nozzles or orifices.

Example 3: The additive manufacturing system of any of examples 1 and 2, wherein the computing device is further configured to: determine that the gas flow profile corresponds to one or more deposition anomalies; and control the energy delivery device, the powder delivery device, and the gas delivery device to reduce a magnitude or occurrence of the one or more deposition anomalies.

Example 4: The additive manufacturing system of example 3, wherein the one or more deposition anomalies include at least one of convective cooling of the build surface or gas contamination of the gas flow.

Example 5: The additive manufacturing system of any of examples 1 through 4, wherein the computing device is further configured to: determine, based on the gas flow profile, one or more deposition anomalies; and control, based on the one or more deposition anomalies, at least one of the energy delivery device, the powder delivery device, or the gas delivery device.

Example 6: The additive manufacturing system of any of examples 1 through 5, wherein the computing device is further configured to: determine, based on the gas flow profile, one or more deposition parameters controllable by the gas delivery device; and control, based on the one or more deposition parameters, the gas delivery device.

Example 7: The additive manufacturing system of example 6, wherein the computing device is configured to determine, via a machine learning model that takes the gas flow profile as input, the one or more deposition parameters using one or more machine learning techniques.

Example 8: The additive manufacturing system of example 7, wherein the machine learning model takes the image data as input.

Example 9: The additive manufacturing system of any of examples 1 through 8, wherein the computing device is configured to: determine, based on the gas flow profile, one or more structural features of the additive manufacturing system or component; and control, based on the one or more structural features, at least one of the energy delivery device, the powder delivery device, or the gas delivery device.

Example 10: The additive manufacturing system of any of examples 1 through 9, wherein the one or more sensors further comprises at least one of a gas purity sensor or a gas flow rate sensor.

Example 11: A method for additive manufacturing includes receiving, by a computing device, image data from one or more sensors of an additive manufacturing system, wherein the one or more sensors comprises at least one Schlieren imaging sensor configured to generate the image data, and wherein the image data is representative of a gas flow of one or more gas streams from a gas delivery device; determining, by the computing device and based on the image data, a gas flow profile of the gas flow, wherein the gas flow profile is a representation of a spatial distribution of density of the gas flow; and controlling, by the computing device and based on the gas flow profile, at least one of: an energy delivery device configured to deliver energy to a build surface of a component to form a melt pool in the build surface of the component; a powder delivery device to direct a powder stream toward the melt pool; or the gas delivery device to direct the one or more gas streams toward or adjacent to the melt pool.

Example 12: The method of example 11, wherein the powder delivery device and the gas delivery device each comprise one or more nozzles or orifices.

Example 13: The method of any of examples 11 and 12, further includes determining, by the computing device, that the gas flow profile corresponds to one or more deposition anomalies; and controlling, by the computing device, the energy delivery device, the powder delivery device, and the gas delivery device to reduce a magnitude or occurrence of the one or more deposition anomalies.

Example 14: The method of example 13, wherein the one or more deposition anomalies include at least one of convective cooling of the build surface or gas contamination of the gas flow.

Example 15: The method of any of examples 11 through 14, further includes determining, by the computing device and based on the gas flow profile, one or more deposition anomalies; and controlling, by the computing device and based on the one or more deposition anomalies, at least one of the energy delivery device, the powder delivery device, or the gas delivery device.

Example 16: The method of any of examples 11 through 15, further includes determining, by the computing device and based on the gas flow profile, one or more deposition parameters controllable by the gas delivery device; and controlling, by the computing device and based on the one or more deposition parameters, the gas delivery device.

Example 17: The method of example 16, further comprising determining, by the computing device and based on the gas flow profile, the one or more deposition parameters using one or more machine learning techniques.

Example 18: The method of example 17, wherein the machine learning model takes the image data as input.

Example 19: The method of any of examples 11 through 18, further includes determining, by the computing device and based on the gas flow profile, one or more structural features of the additive manufacturing system or component; and controlling, by the computing device and based on the one or more structural features, at least one of the energy delivery device, the powder delivery device, or the gas delivery device.

Example 20: The method of any of examples 11 through 19, wherein the one or more sensors further comprises at least one of a gas purity sensor or a gas flow rate sensor.

Various examples have been described. These and other examples are within the scope of the following claims.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool;
a gas delivery device configured to direct one or more gas streams toward or adjacent to the melt pool;
one or more sensors comprising at least one Schlieren imaging sensor configured to generate image data representative of a gas flow of the one or more gas streams; and
a computing device configured to:
receive the image data from the at least one Schlieren imaging sensor;
determine a gas flow profile of the gas flow based on the image data, wherein the gas flow profile is a representation of a spatial distribution of density of the gas flow; and
control at least one of the energy delivery device, the powder delivery device, or the gas delivery device based on the gas flow profile.

2. The additive manufacturing system of claim 1, wherein the powder delivery device and the gas delivery device each comprise one or more nozzles or orifices.

3. The additive manufacturing system of claim 1, wherein the computing device is further configured to:
determine that the gas flow profile corresponds to one or more deposition anomalies; and
control the energy delivery device, the powder delivery device, and the gas delivery device to reduce a magnitude or occurrence of the one or more deposition anomalies.

4. The additive manufacturing system of claim 3, wherein the one or more deposition anomalies include at least one of convective cooling of the build surface or gas contamination of the gas flow.

5. The additive manufacturing system of claim 1, wherein the computing device is further configured to:
determine, based on the gas flow profile, one or more deposition anomalies; and
control, based on the one or more deposition anomalies, at least one of the energy delivery device, the powder delivery device, or the gas delivery device.

6. The additive manufacturing system of claim 1, wherein the computing device is further configured to:
determine, based on the gas flow profile, one or more deposition parameters controllable by the gas delivery device; and
control, based on the one or more deposition parameters, the gas delivery device.

7. The additive manufacturing system of claim 6, wherein the computing device is configured to determine, via a machine learning model that takes the gas flow profile as input, the one or more deposition parameters using one or more machine learning techniques.

8. The additive manufacturing system of claim 7, wherein the machine learning model takes the image data as input.

9. The additive manufacturing system of claim 1, wherein the computing device is configured to:
determine, based on the gas flow profile, one or more structural features of the additive manufacturing system or component; and
control, based on the one or more structural features, at least one of the energy delivery device, the powder delivery device, or the gas delivery device.

10. The additive manufacturing system of claim 1, wherein the one or more sensors further comprises at least one of a gas purity sensor or a gas flow rate sensor.

11. A method for additive manufacturing, comprising:
receiving, by a computing device, image data from one or more sensors of an additive manufacturing system, wherein the one or more sensors comprises at least one Schlieren imaging sensor configured to generate the image data, and wherein the image data is representative of a gas flow of one or more gas streams from a gas delivery device;
determining, by the computing device and based on the image data, a gas flow profile of the gas flow, wherein the gas flow profile is a representation of a spatial distribution of density of the gas flow; and
controlling, by the computing device and based on the gas flow profile, at least one of:
an energy delivery device configured to deliver energy to a build surface of a component to form a melt pool in the build surface of the component;
a powder delivery device to direct a powder stream toward the melt pool; or
the gas delivery device to direct the one or more gas streams toward or adjacent to the melt pool.

12. The method of claim 11, wherein the powder delivery device and the gas delivery device each comprise one or more nozzles or orifices.

13. The method of claim 11, further comprising:
determining, by the computing device, that the gas flow profile corresponds to one or more deposition anomalies; and
controlling, by the computing device, the energy delivery device, the powder delivery device, and the gas delivery device to reduce a magnitude or occurrence of the one or more deposition anomalies.

14. The method of claim 13, wherein the one or more deposition anomalies include at least one of convective cooling of the build surface or gas contamination of the gas flow.

15. The method of claim 11, further comprising:
determining, by the computing device and based on the gas flow profile, one or more deposition anomalies; and
controlling, by the computing device and based on the one or more deposition anomalies, at least one of the energy delivery device, the powder delivery device, or the gas delivery device.

16. The method of claim 11, further comprising:
determining, by the computing device and based on the gas flow profile, one or more deposition parameters controllable by the gas delivery device; and
controlling, by the computing device and based on the one or more deposition parameters, the gas delivery device.

17. The method of claim 16, further comprising determining, by the computing device and based on the gas flow profile, the one or more deposition parameters using one or more machine learning techniques.

18. The method of claim 17, wherein the machine learning model takes the image data as input.

19. The method of claim 11, further comprising:
determining, by the computing device and based on the gas flow profile, one or more structural features of the additive manufacturing system or component; and
controlling, by the computing device and based on the one or more structural features, at least one of the energy delivery device, the powder delivery device, or the gas delivery device.

20. The method of claim 11, wherein the one or more sensors further comprises at least one of a gas purity sensor or a gas flow rate sensor.
